(19) United States
(12) Patent Application Publication
(10) Pub. No.: US 2022/0372915 A1
(43) Pub. Date: Nov. 24, 2022

(54) PASSIVE FUEL COUPLED DYNAMIC MITIGATION DEVICE

(71) Applicant: General Electric Company, Schenectady, NY (US)

(72) Inventors: Gurunath Gandikota, Bangalore (IN); Steven Clayton Vise, Loveland, OH (US); Clayton S. Cooper, Cincinnati, OH (US); Michael A. Benjamin, Cincinnati, OH (US)

(21) Appl. No.: 17/323,088

(22) Filed: May 18, 2021

(51) Int. Cl. F02C 7/22

(52) U.S. Cl. CPC F02C 7/222; F05D 2220/32; F05D 2240/35

(57) ABSTRACT

A gas turbine engine that is configured to mitigate fuel coupled dynamics. The engine includes a combustor, a fuel delivery system, a fuel manifold line; and a device configured to mitigate fuel coupled dynamics. The device is attached to the fuel manifold line and includes a housing and a reflector. The housing includes a wall and the wall defines a housing surface that is configured to reflect waves conducted by fuel within the fuel delivery system. The reflector is positioned within the housing and the reflector includes an anterior surface that is configured to reflect waves conducted by fuel within the fuel delivery system such that wave the reflected waves can strike the surface.

### BACKGROUND OF THE INVENTION

The present invention relates generally to a fuel delivery system for a gas turbine engine and more specifically, to a device for mitigating oscillations, i.e., fuel coupled dynamics, caused by acoustic resonance.

Conventional gas turbine engines include a combustion section in which fuel is burned to input heat to the engine cycle and its operate using one or several types or combinations of fuel, such as propane, ethane, hydrogen, or jet fuel. Additionally, the combustion section may include one of several types of combustors (e.g., can, cannular, annular) for burning such fuel.

Typical combustion sections incorporate one or more fuel nozzles whose function is to receive the fuel and introduce such fuel into an air flow stream so that it can atomize and burn. Gas turbine engines additionally include a fuel delivery system for providing fuel from one or more fuel tanks to the combustion section, or more particularly, to the one or more fuel nozzles of the combustion section.

However, during operation of the gas turbine engine, the fuel delivery system may be subjected to vibrations or other mechanical perturbations affecting the delivery of fuel to the one or more fuel nozzles. For example, vibrations can cause the fuel within the fuel delivery system to flow in an inconsistent manner. More specifically, the fuel may flow through the fuel delivery system in accordance with a mechanical resonance consistent with the vibrations and mechanical perturbations thus causing inconsistencies in the fuel flow. These inconsistencies in the fuel flow through the fuel delivery system can create inconsistent fuel delivery to the fuel nozzles, potentially resulting in undesirable combustion dynamics. Such undesirable combustion dynamics are referred to herein as “fuel coupled dynamics.” Accordingly, a fuel delivery system capable of providing fuel to the fuel nozzles of the combustion section with fuel more consistently would be useful.

### BRIEF DESCRIPTION OF THE INVENTION

The technology disclosed herein is configured to reduce the effect of fuel coupled dynamics on combustor performance and durability. Accordingly, a fuel manifold is provided with structure that is configured to utilize the wave nature of acoustic waves to mitigate fuel coupled dynamics.

According to one aspect of the present invention, there is provided a gas turbine engine that is configured to mitigate fuel coupled dynamics. The engine includes a combustor, a fuel delivery system, a fuel manifold line; and a device configured to mitigate fuel coupled dynamics. The device is attached to the fuel manifold line and includes a housing and a reflector. The housing includes a wall and the wall defines a housing surface that is configured to reflect waves conducted by fuel within the fuel delivery system. The reflector is positioned within the housing and the reflector includes an anterior surface that is configured to reflect waves conducted by fuel within the fuel delivery system such that wave the reflected waves can strike the surface.

According to another aspect of the present invention, there is provided a gas turbine engine that includes a fuel delivery system positioned upstream of a combustor. The fuel delivery system includes a device that is configured to mitigate the effects of fluid coupled dynamics within the combustor. The device includes a housing and a reflector. The housing includes a wall and the wall defines a housing surface that is configured to reflect waves conducted by fuel within the fuel delivery system. The reflector is positioned within the housing. the reflector includes anterior surface that is configured to reflect waves conducted by fuel within the fuel delivery system such that wave the reflected waves can strike the surface.

### BRIEF DESCRIPTION OF THE DRAWINGS

The invention, in accordance with preferred and exemplary embodiments, together with further objects and advantages thereof, is more particularly described in the following detailed description taken in conjunction with the accompanying drawings in which:

FIG. 1 is a perspective schematic view of a fuel manifold that includes devices for mitigating fluid coupled dynamics according to the disclosed technology.

FIG. 2 is an axial, partly sectional view of a portion of an exemplary annular combustor of a turbofan gas turbine engine that is fluidly connected to a fuel delivery system, such as that of FIG. 1, wherein the fuel delivery system includes a device constructed in accordance with the disclosed technology;

FIG. 3 shows a sectional side view of a device for mitigating fluid coupled dynamics according to the disclosed technology; and

FIG. 4 shows a side view of another embodiment of the disclosed technology.

### DETAILED DESCRIPTION OF THE INVENTION

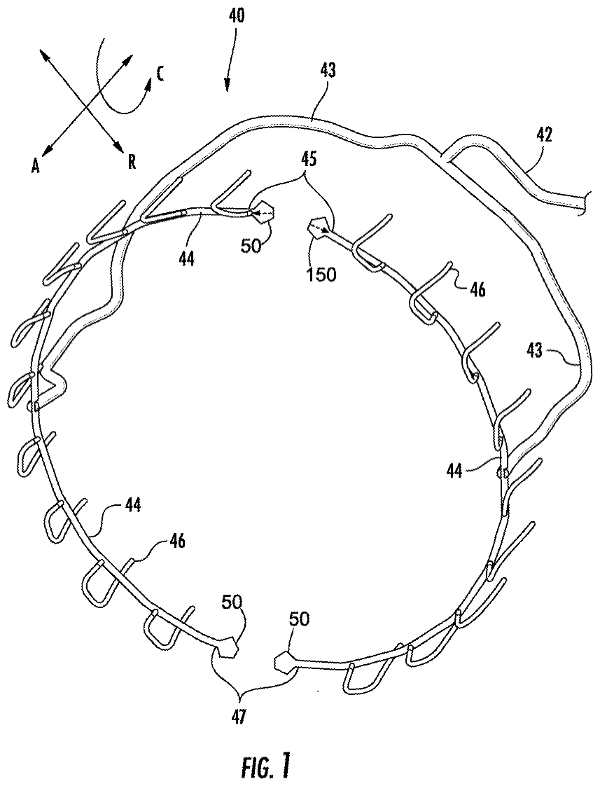

Referring to the drawings wherein identical reference numerals denote the same elements throughout the various views, the disclosed technology illustrated in FIG. 1 is a mitigation device 50 configured to reduce or mitigate fluid coupled dynamics (FCD). The device is utilized in a gas turbine engine and more specifically, as part of a fuel delivery system 40 for combustors of gas turbine engines.

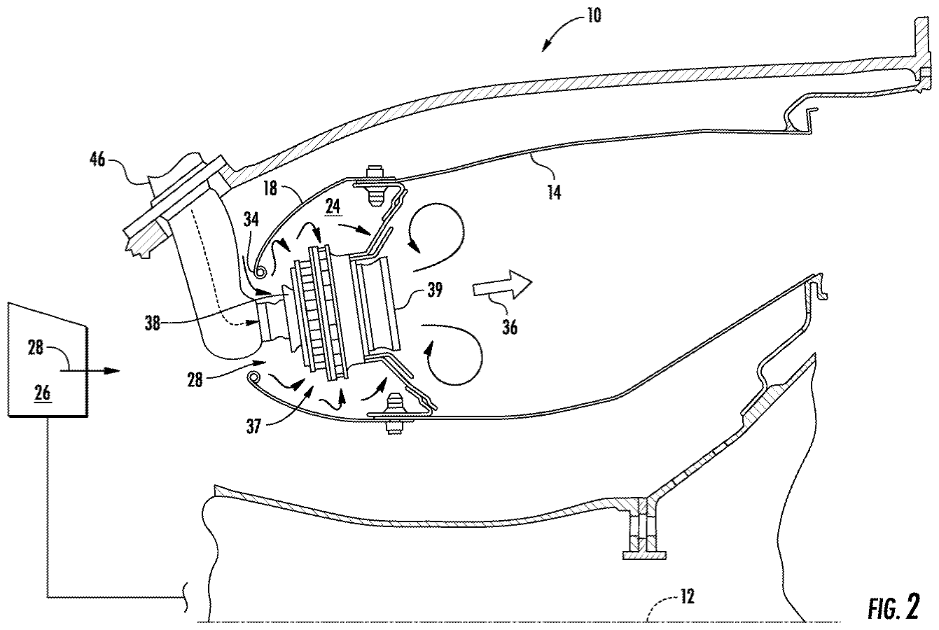

Referring now to FIG. 2, a conventional gas turbine engine can include multiple annular combustors 10 that are arranged around an axis 12. The annular combustor 10 is suitably mounted inside a casing coaxially about a longitudinal or axial centerline axis 12. The combustor 10 includes radially outer and inner annular combustor liner 14 which is suitably joined at upstream ends thereof to an annular combustor dome 18. The combustor 10 is a singular annular combustor design and includes radially outer and inner cowls extending axially forwardly from the dome 18 at the juncture with the outer and inner liners to define an annular plenum 24 on the upstream side of the dome 18.

A suitable compressor 26, such as a conventional multistage axial compressor, is positioned upstream of the annular plenum 24 and is configured for pressurizing an airstream 28 as the airstream 28 flows downstream therethrough. The pressurized airstream 28 is channeled axially downstream from the compressor 26 through a suitable diffuser and is introduced into the plenum 24 through a first annular inlet 34. The combustor 10 as described above and the compressor 26 may have any conventional configuration.

A plurality of swirlers 37 is mounted in the combustor dome 18. A nozzle 38 is configured to inject fuel into the swirler 37 wherein it is mixed within a throat with pressurized airstream air 28 for generating a fuel and air mixture. The fuel and air mixture is suitably ignited for generating hot combustion gases that collectively flow downstream through a channel defined by the combustor liner 14. The combustion gases 36 are discharged from the outlet end of the combustor into a high pressure turbine (not shown) which extracts energy therefrom for powering the compressor 26.

A low pressure turbine (not shown) is disposed downstream of the high pressure turbine and is suitably configured for producing output power, such as for powering an upstream fan in a typical turbofan gas turbine engine aircraft application.

Referring now with more particularity to the disclosed technology, as shown in FIG. 1, the exemplary fuel delivery system 40 generally includes a primary feed tube 42 and at least one fuel manifold line 44. The fuel delivery system 40 extends generally along the circumferential direction C. Such a configuration may allow for the plurality of pigtail fuel lines 46 connected thereto to more easily extend to the fuel nozzles 39 of the gas turbine engine when installed. Notably, in other embodiments the fuel delivery system 40 include any suitable number of fuel manifold line 44.

The fuel delivery system 40 is connected via a primary feed tube 42 to a source for fuel such as one or more fuel pumps, fuel valves, and/or fuel tanks (not shown). Each fuel manifold line 44 is fluidly connected to the primary feed tube 42 via a secondary feed tube 43 for receiving fuel from the feed tube 42. Each fuel manifold line 44 has a first end 45 and a second end 47. A plurality of pigtail fuel lines 46 extend from each fuel manifold line 44 and are positioned between the first end 45 and the second end 47. Each of the plurality of pigtail fuel lines 46 are fluidly connected to the fuel manifold line 44 and configured to fluidly connect to a fuel nozzle 39 of the plurality of fuel nozzles 39.

As shown in FIG. 1, either a mitigation device 50 or an alternative embodiment, multiple cone mitigation device 150 (discussed further below) s fluidly connected to each of the first end 45 and the second end 47 of the fuel manifold line 44. It should be appreciated that a fuel manifold line 44 can be attached to only one mitigation device 50 according to some embodiments and that mitigation device 50 can be positioned at a location along the fuel manifold line 44 that is not either the first end 45 or the second end 47.

Each mitigation device 50 includes a housing 60 that defines a chamber 61. A reflector 51 is positioned within the chamber 61. The housing 60 includes at least one side-wall 62 and an end-wall 63. The at least one side-wall 62 defines a housing wall surface 64. The end wall 63 defines an end-wall surface 65. The housing wall surface 64 and the end wall surface 65 are configured to reflect acoustic waves that are transmitted within the fuel manifold line 44. In some embodiments, the housing 60 is some geometric shape other than conical. In this regard, the housing 60 can be generally cubical, pentagonal, hexagonal, or other shape or combination of shapes.

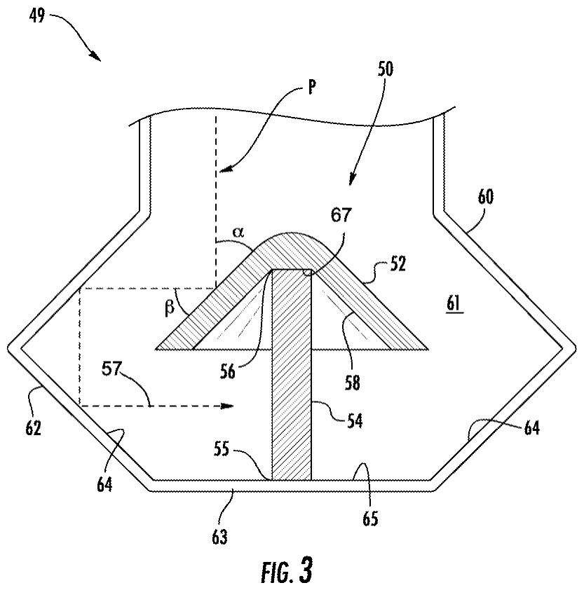

Referring now to FIG. 3, each reflector 51 is a generally conical device that defines an anterior surface 52 and an interior surface 58. The anterior surface 52 is positioned such that fuel flowing along an incoming fuel flowpath P contacts the anterior surface 52 before it contacts other portions of reflector 51. The anterior surface 52 defines an angle α with respect to incoming fuel flowpath P. According to the illustrated embodiment, the angle α is preferably between about 20° and about 70°, more preferably between about 30° and about 60°, more preferably between about 40° and about 50°, and most preferably about 45°. The angle α of the cone can be optimized to maximize mitigation of a particular frequency of FCD. In this regard, the angle α can be between 0° and 90°.

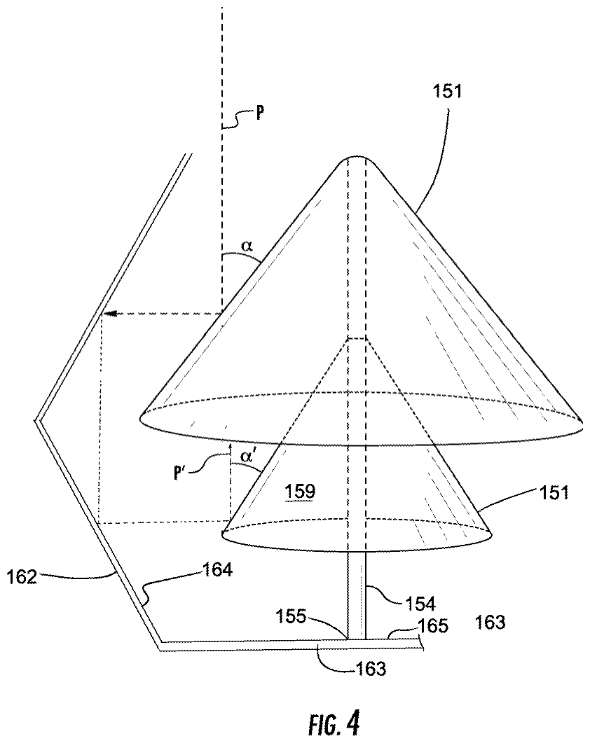

It should be appreciated that as shown in FIG. 3, the line 57 is coincident with a portion of the flowpath P. The surface 52 also defines an angle β with respect to an imaginary line 57 that is substantially parallel to the end-wall surface 65 of the end-wall 63. The angle β is equal to the angle α. The reflector 51 can supported by in multiple ways: using a single prop, or a tripod arrangement etc. As shown in FIG. 4, the reflector 51 is supported by a post 54. The post 54 extends from a first end 55 that is connected to the end wall 63 to a second end 56 that is connected to the reflector 51 at an underside 67 of the reflector 51.

Each mitigation device 50 is configured to passively interact with waves caused by structural vibrations to reduce the introduction of frequencies of vibration into at least the fuel manifold line 44 which is component of a fuel system of the turbofan gas turbine engine. As used herein, the term “mitigate” is understood to have its common meaning: “to make less severe.” It should be understood that mitigation of the fluid coupled dynamics refers to the reduction of fluid coupled dynamics in amplitude and/or frequency. In this regard, the mitigation device 50 is configured to utilize a combination of wave reflection and subsequent cancellation of acoustic waves via wave interference.

The currently disclosed technology provides a mitigation device 50 that is configured for mitigation of FCD in Lean/Rich burn combustors. It should be appreciated that the mitigation device 50 can be attached to the fuel manifold line 44 in conventionally known manners including threaded attachment or being welded to the ends of the manifold line 44. A threaded connection, i.e., screwable arrangement, allows for regular cleaning without major overhaul.

It should be appreciated that mitigation device 50 as described above can be additively manufactured.

The presently disclosed technology can be better understood from a description of the operation thereof. During operation of the gas turbine engine, mechanical vibrations are generated and transmitted to the structural components of the fuel delivery system 40. Such mechanical vibrations are transmitted to the fuel contained within the fuel system 40. The vibrations occur as waves within the fuel and travel along the fuel manifold 44. Such acoustic waves when they travel inside the manifold line 44, undergo multiple reflections inside the mitigation device 50 and eventually get cancelled. The device utilizes a combination of wave reflection and subsequently cancellation of acoustic waves by virtue of its geometry. In this manner, potential simple hydraulic manifold pressure oscillation extremes are cancelled.

One problem with conventional fuel delivery systems is that they can be the source of fuel coupled dynamics, caused by acoustic resonance, which can damage combustors. By using this technique, the acoustic resonance inside the fluid manifold can be cancelled efficiently. Furthermore, these devices are independent of the frequency of acoustic resonance. They mitigate acoustic oscillations at any frequency thereby improving efficiency.

Referring now to FIG. 4, the interior structure of the alternative embodiment multiple cone mitigation device 150 is shown. Each mitigation device 150 is substantially similar to the mitigation device 50 and can be generally understood from the description thereof.

The multiple cone mitigation device 150 includes a first reflector 151 that is supported by a post 154 that is attached, at an end 155, to an end wall surface 165 of and end wall 163. A second reflector 153 that is supported by the post 154 such that the second reflector 153 is positioned between the first reflector 151 and the end 155 of the post 154. The second reflector is substantially similar to the first reflector 151 and can be understood from the description above. The secondary reflector 151 includes the anterior surface 159 that is positioned such that fuel flowing along an incoming fuel flowpath P contacts the anterior surface 159 before it contacts other portions of reflector 151. The anterior surface 152 defines an angle α with respect to incoming fuel flowpath P. The secondary reflector 151 includes an anterior surface 159. The anterior surface 159 defines an angle α′ with line P′ which is an imaginary continuation of flowpath P after the flowpath P intersects anterior surface 152 and interior surface 164. Angle α′ can be equal to angle α. In other embodiments angle α′ is not equal to angle α. Stacking cones of different angles maximizes mitigation for multiple frequencies. It should be appreciated that while any given reflector 151 can mitigate FCD at any frequencies, the above-described variations in shape or configuration, i.e., stacking, can increase the degree of mitigation for a given frequency or range of frequencies.

The above-described fuel coupled dynamics mitigation device 50 is configured to reduce or eliminate effects of fuel coupled dynamics in gas turbine combustors. In operation, mitigation device 50 utilizes a combination of wave reflection and subsequent cancellation by interference. One commercial advantage of mitigation device 50 is that effects of fluid coupled dynamics can be cancelled efficiently. Another commercial advantage of mitigation device 50 is that it is configured to mitigate acoustic oscillations at any frequency and thus is independent of the frequency of acoustic resonance. Another advantage is that the mitigation device 50 can be attached easily by known methods such as threaded screws and welds.

The FCD mitigation device described herein has advantages over the prior art. It will reduce FCD in a very broad band frequency range and it will work irrespective of the shape of the fuel manifold to which it is attached. It can be manufactured simply and economically, is very durable, and provides operability benefits thus leading to reduced costs.

The foregoing has described a fluid coupled dynamic mitigation device. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not limited to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

Further aspects of the invention are provided by the subject matter of the following numbered clauses:

1. A gas turbine engine configured to mitigate fuel coupled dynamics, the engine comprising: a combustor; a fuel delivery system; a fuel manifold line; and a device configured to mitigate fuel coupled dynamics attached to the fuel manifold line, the device comprising: a housing that includes a wall and the wall defines a housing surface that is configured to reflect waves conducted by fuel within the fuel delivery system; a first reflector positioned within the housing and the reflector includes anterior surface that is configured to reflect waves conducted by fuel within the fuel delivery system such the reflected waves can strike the surface.

2. The gas turbine engine in accordance with any preceding clause, wherein the housing defines an end wall surface and the first reflector is spaced-apart from end wall surface

3. The gas turbine engine in accordance with any preceding clause, wherein the housing defines an end wall surface and the first reflector is supported by a post that extends from the end wall surface such that the first reflector is spaced-apart from end wall surface.

4. The gas turbine engine in accordance with any preceding clause, wherein the fuel manifold line defines a path P that intersects the anterior surface of the first reflector and the anterior surface of the first reflector defines an angle α with the path P that is between about 20° and about 70°.

5. The gas turbine engine in accordance with any preceding clause, wherein the angle α is between about 30° and about 60°.

6. The gas turbine engine in accordance with any preceding clause, wherein the angle α is between about 40° and about 50°.

7. The gas turbine engine in accordance with any preceding clause, wherein the angle α is about 45°.

8. The gas turbine engine in accordance with any preceding clause, wherein a second reflector is also supported by the post such that the second reflector is stacked below the first reflector

9. The gas turbine engine in accordance with any preceding clause, wherein the fuel manifold line defines a path P that intersects a first anterior surface of the first reflector and intersects a second anterior surface of the second reflector such that it defines an angle α′ with the path P that is between about 20° and about 70°.

10. The gas turbine engine in accordance with any preceding clause, wherein the angle α′ is between about 30° and about 60°.

11. The gas turbine engine in accordance with any preceding clause, wherein the angle α′ is between about 40° and about 50°.

12. The gas turbine engine in accordance with any preceding clause, wherein the angle α′ is about 45°.

13. A gas turbine engine that includes a fuel delivery system positioned upstream of a combustor and the fuel delivery system includes a device that is configured to mitigate the effects of fluid coupled dynamics within the combustor, the device comprising:

a housing that includes a wall and the wall defines a housing surface that is configured to reflect waves conducted by fuel within the fuel delivery system; and

a reflector positioned within the housing and the reflector includes anterior surface that is configured to reflect waves conducted by fuel within the fuel delivery system such that wave the reflected waves can strike the surface.

14. The gas turbine engine in accordance with any preceding clause, wherein the housing defines an end wall surface and the reflector is spaced-apart from end wall surface

15. The gas turbine engine in accordance with any preceding clause, wherein the housing defines an end wall surface and the reflector supported by a post that extends from the end wall surface such that the reflector is spaced-apart from end wall surface

16. The gas turbine engine in accordance with any preceding clause, wherein a second reflector is also supported by the post such that the second reflector is stacked below the reflector.

17. The gas turbine engine in accordance with any preceding clause, wherein the fuel manifold line defines a path P that intersects the anterior surface of the reflector and the anterior surface of the reflector defines an angle α with the path P that is between about 20° and about 70°.

18. The gas turbine engine in accordance with any preceding clause, wherein the fuel manifold line defines a path P that intersects the anterior surface of the reflector and the anterior surface of the reflector defines an angle α with the path P that is between about 30° and about 60°.

19. The gas turbine engine in accordance with any preceding clause, wherein the fuel manifold line defines a path P that intersects the anterior surface of the reflector and the anterior surface of the reflector defines an angle α with the path P that is between about 40° and about 50°.

20. The gas turbine engine in accordance with any preceding clause, wherein the fuel manifold line defines a path P that intersects the anterior surface of the reflector and the anterior surface of the reflector defines an angle α with the path P that is about 45°.

1. A gas turbine engine configured to mitigate fuel coupled dynamics, the gas turbine engine comprising:
a combustor;
a fuel delivery system;
a fuel manifold line; and
a device configured to mitigate the fuel coupled dynamics attached to the fuel manifold line, the device comprising:
a housing that includes a wall and the wall defines a housing wall surface that reflects reflected acoustic waves conducted by fuel within the fuel delivery system; and
a first reflector positioned within the housing and the first reflector includes an anterior surface that reflects acoustic waves which form the reflected acoustic waves conducted by the fuel within the fuel delivery system such that the reflected acoustic waves strike the housing wall surface.

2. The gas turbine engine in accordance with claim 1, wherein the housing defines an end wall surface and the first reflector is spaced-apart from the end wall surface.

3. The gas turbine engine in accordance with claim 1, wherein the housing defines an end wall surface and the first reflector is supported by a post that extends from the end wall surface such that the first reflector is spaced-apart from the end wall surface.

4. The gas turbine engine in accordance with claim 1, wherein the fuel manifold line defines a path P that intersects the anterior surface of the first reflector and the anterior surface of the first reflector defines an angle α with the path P that is between about 20° and about 70°.

5. The gas turbine engine in accordance with claim 4, wherein the angle α is between about 30° and about 60°.

6. The gas turbine engine in accordance with claim 5, wherein the angle α is between about 40° and about 50°.

7. The gas turbine engine in accordance with claim 6, wherein the angle α is about 45°.

8. The gas turbine engine in accordance with claim 4, wherein a second reflector is supported by a post such that the second reflector is stacked below the first reflector.

9. The gas turbine engine in accordance with claim 8, wherein the fuel manifold line defines a path P that intersects the anterior surface which is a first anterior surface and intersects a second anterior surface of the second reflector such that the second anterior surface defines an angle α′ with the path P that is between about 20° and about 70°.

10. The gas turbine engine in accordance with claim 9, wherein the angle α′ is between about 30° and about 60°.

11. The gas turbine engine in accordance with claim 10, wherein the angle α′ is between about 40° and about 50°.

12. The gas turbine engine in accordance with claim 11, wherein the angle α′ is about 45°.

13. A gas turbine engine that includes a fuel delivery system positioned upstream of a combustor and the fuel delivery system includes a device that is configured to mitigate effects of fluid coupled dynamics within the combustor, the device comprising:
a housing that includes a wall and the wall defines a housing wall surface that reflects reflected acoustic waves conducted by fuel within the fuel delivery system; and
a first reflector positioned within the housing and the first reflector includes an anterior surface that reflects acoustic waves which form the reflected acoustic waves conducted by the fuel within the fuel delivery system such that the reflected acoustic waves strike the housing wall surface.

14. The gas turbine engine in accordance with claim 13, wherein the housing defines an end wall surface and the first reflector is spaced-apart from the end wall surface.

15. The gas turbine engine in accordance with claim 13, wherein the housing defines an end wall surface and the first reflector is supported by a post that extends from the end wall surface such that the first reflector is spaced-apart from the end wall surface.

16. The gas turbine engine in accordance with claim 15, wherein a second reflector is supported by the post such that the second reflector is stacked below the first reflector.

17. The gas turbine engine in accordance with claim 13, wherein a fuel manifold line defines a path P that intersects the anterior surface of the first reflector and the anterior surface of the first reflector defines an angle α with the path P that is between about 20° and about 70°.

18. The gas turbine engine in accordance with claim 17, wherein the angle α is between about 30° and about 60°.

19. The gas turbine engine in accordance with claim 18, wherein the angle α is between about 40° and about 50°.

20. The gas turbine engine in accordance with claim 19, wherein the angle α is about 45°.
